(19) United States
(12) Patent Application Publication
(10) Pub. No.: US 2003/0061758 A1
(43) Pub. Date: Apr. 3, 2003

(54) Composition and method for exterminating subterranean burrowing air-breathing pests

(76) Inventor: Harold W. Wilson, El Paso, TX (US)

Correspondence Address: JACOBSON HOLMAN PLLC, 400 SEVENTH STREET N.W., SUITE 600, WASHINGTON, DC, 20004, US

(21) Appl. No.: 09/964,526

(22) Filed: Sep. 28, 2001

(51) Int. Cl. A01M 1/00

(52) U.S. Cl. 43/124

(57) ABSTRACT

A composition comprising at least one carbonate compound and at least one acid compound which yields carbon dioxide gas in the presence of a sufficient amount of water is disclosed. Also disclosed are methods for producing carbon dioxide gas and exterminating subterranean burrowing, air-breathing pests and methods for providing nutrition to plants and soil.

### BACKGROUND OF THE INVENTION

1. Field of the Invention

The present invention relates generally to a composition and method for the extermination of subterranean burrowing air-breathing pests. In particular, the present invention relates to a composition and method for suffocating subterranean burrowing air-breathing pests with carbon dioxide gas.

2. Description of the Related Art

For years, various devices, compositions and methods have been unsuccessfully employed in attempts to exterminate subterranean burrowing, air-breathing pests which include animals and insects such as moles, gofers, ants, and the like. For example, U.S. Pat. No. 4,829,706 discloses an apparatus that directs engine exhaust into a burrow or tunnel of a ground-burrowing rodent to asphyxiate, poison, or drive the rodent out from an underground habitat. This apparatus is undesirable and ineffective as it is bulky, noisy, and scares the animal or pest away. The animal or pest, however, returns when the internal combustion engine is turned off.

U.S. Pat. No. 4,026,330 discloses a device, which attaches to a gas generating apparatus such as a gasoline powered lawn mower and transmits the exhaust gas into an underground cavity to asphyxiate the rodents inhabiting the cavity. Like U.S. Pat. No. 4,829,706, this method and device are undesirable and ineffective as the device is noisy and scares the rodents away until the gas generating apparatus is turned off.

U.S. Pat. No. 4,833,818 discloses a method and apparatus for introducing into a subterranean tunnel network a heavier than air gas, such as carbon dioxide, to suffocate the pest residing in the subterranean tunnel network. Although this method and apparatus are relatively quiet, so as not to alert the pest, it is bulky and requires supervision so that a child does not attempt to play with the gas chamber and accidentally suffocate.

U.S. Pat. No. 4,741,121 discloses an animal trap, which kills a trapped animal with a gas such as carbon dioxide. This animal trap may be effective exterminating a rodent; however, like many prior methods it is ineffective as one must first coax the animal into the trap.

Therefore, the need still exists for a safe, inexpensive, and effective method for the extermination of subterranean burrowing, air-breathing pests.

### SUMMARY OF THE INVENTION

In order to overcome the drawbacks of prior methodology, the present invention provides a composition comprising at least one carbonate compound and at least one acid compound, which composition will produce a toxic amount of carbon dioxide gas when in the presence of a sufficient amount of water. The at least one acid compound, is preferably supplied by an appropriate animal litter. The carbonate compound and the acid compound are in amounts which preferably provide a 1:1 stoichiometric ratio, or about a 1:1 stoichiometric ratio. The carbonate compound may be calcium carbonate, magnesium carbonate, sodium carbonate, or sodium bicarbonate and may be from limestone, dolomite, soda ash or baking soda. The acid compound may be Ca(HSO₄)₂, Mg(HSO₄)₂, Mg(HSO₄)₂, Ca(HPO₄)₂, CaHPO₄, or MgHPO₄, and may be from a superphosphate fertilizer or a compound or composition treated with concentrated acid. The carbonate compound is preferably anhydrous and powdered or granular. Preferably, the acid compound is provided by a source which is dry, solid, anhydrous, and granular.

In addition, the present invention provides a method of making carbon dioxide gas by adding a sufficient amount of water to a composition comprising at least one carbonate compound and animal litter having at least one acid compound. The compounds again are preferably in a 1:1 stoichiometric ratio. The carbonate compound may be calcium carbonate, magnesium carbonate, sodium carbonate, or sodium bicarbonate, and the acid compound may be Ca(HSO₄)₂, Mg(HSO₄)₂, Mg(HSO₄)₂ Ca(HPO₄)₂, CaHPO₄, or MgHPO₄. The carbonate compound is preferably anhydrous and powdered or granular, and the acid compound is provided by a source which is dry, solid, anhydrous, and granular. The sufficient amount of water may be provided by adding to the composition of the present invention a material comprising about 30% water by weight. Preferred materials include, ground wood, sawdust, or ground cellulosic material.

The present invention also provides a method of exterminating a subterranean burrowing pest by placing in a burrow or tunnel of the subterranean burrowing pest a composition comprising at least one carbonate compound and at least one acid compound and adding a sufficient amount of water to enable a chemical reaction between the carbonate compound and the acid compound to generate carbon dioxide. The carbonate compound and the acid compound are again in amounts which provide preferably a 1:1 stoichiometric ratio. The carbonate compound may be calcium carbonate, magnesium carbonate, sodium carbonate, or sodium bicarbonate, and the acid compound may be Ca(HSO₄)₂, Mg(HSO₄)₂, Mg(HSO₄)₂ Ca(HPO₄)₂, CaHPO₄, or MgHPO₄. The carbonate compound is preferably anhydrous and powdered or granular. Preferably, the acid compound is provided by a source which is dry, solid, anhydrous, and granular. The water is preferably added in the form of a material comprising about 30% by weight water.

Further, the present invention also provides a method of providing nutrition to soil and plants by adding to a burrow or tunnel of a subterranean burrowing pest a composition comprising at least one carbonate compound and animal litter having at least one acid compound, which composition yields carbon dioxide gas when in the presence of a sufficient amount of water. As above, the carbonate compound and the acid compound are in amounts which preferably provide a 1:1 stoichiometric ratio. The carbonate compound may be calcium carbonate, magnesium carbonate, sodium carbonate, or sodium bicarbonate, and the acid compound may be Ca(HSO₄)₂, Mg(HSO₄)₂, Mg(HSO₄)₂ Ca(HPO₄)₂, CaHPO₄, or MgHPO₄. The carbonate compound is preferably anhydrous and powdered or granular, and the acid compound is preferably provided by a source which is dry, solid, anhydrous, and granular.

The present invention provides a safe, inexpensive, and efficient composition and method for exterminating subterranean burrowing, air-breathing pests which result in minimal disturbance of the pest as well as its domicile. Although carbon dioxide gas reacts with water in atmospheric air to form a product know as carbonic acid which has measurable acidic taste and is readily discernable by most animals when its content is around 0.03% or above, production of the colorless and odorless carbon dioxide gas “toxic” atmosphere by the composition and method disclosed herein does not distress, disturb, detract, agitate, or arouse the pest by making any radical changes of the general conditions present in its environment

It is to be understood that both the foregoing general description and the following detailed description are exemplary only and are intended to provide further explanation of the invention as claimed.

### DESCRIPTION OF THE PREFERRED EMBODIMENTS

Although only preferred embodiments of the invention are explained in detail, it is to be understood that the invention is not limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents which operate in a similar manner to accomplish a similar purpose.

The present invention provides a composition and method for the extermination of subterranean burrowing, air-breathing pests which include animals and insects such as gofers, moles, rats, mice, ants, and the like. In particular, the present invention provides a composition and method which asphyxiates subterranean burrowing air-breathing pests by altering the ambient air in the burrow or tunnel where the subterranean pest resides to a toxic amount of carbon dioxide gas. The method of the present invention alters the quality of the ambient air as present in a pest's burrow or domicile to a toxic amount of carbon dioxide gas, thereby causing severe disorientation, hypertension, respiratory failure, pulmonary edema, coma, death, or a combination thereof of the pest.

As used herein a “toxic amount of carbon dioxide gas” is an amount that is sufficient to cause disorientation, hypertension, respiratory failure, pulmonary edema, comma, death, or a combination thereof, to a subterranean burrowing air-breathing pest. Typically, a toxic amount of carbon dioxide gas is between about 10% to about 20% carbon dioxide by volume. However, one of ordinary skill in the art may readily determine by routine methods the toxic amount of carbon dioxide gas that may be used to exterminate a given pest.

The composition of the present invention is a mixture combining at least one carbonate compound with at least one acid compound in about equal parts. The carbonate compound is preferably anhydrous and powered or granular. Examples of suitable carbonate compounds include calcium carbonate, magnesium carbonate, sodium carbonate, sodium bicarbonate, and the like. Suitable sources of such carbonate compounds include limestone, dolomite, soda ash, baking soda, and the like. Suitable acid compounds include Ca(HSO₄)₂, Mg(HSO₄)₂, Mg(HSO₄)₂ Ca(HPO₄)₂, CaHPO₄, MgHPO₄, and the like. Suitable sources of such acid compounds include acid sulfate and acid phosphate salt as present in “superphosphate” fertilizers as well as in products which are made by treating compounds such gypsum, tricalcium phosphate, and similar chemical substances with concentrated sulfuric acid, concentrated phosphoric acid, or both. For example, poultry excrement or poultry litter treated with concentrated acid may be used as the source of the acid compound. Preferred sources of acid compounds are dry, solid, anhydrous and granular, and produce free acid upon hydrolysis, but remain stable in the anhydrous state. The amount of carbonate and the amount of acid in the mixture preferably provide about a 1:1 stoichiometric ratio. For example, the following chemical equation 1 provides the stoichiometric amounts of calcium carbonate and sulfuric acid which provide carbon dioxide:

CaCO₃+H₂SO₄+H₂O→CaSO₄.2H₂O+CO₂ (1)

The mixture may further comprise a water to enable the reaction of the carbonate and acid to yield CO₂. Alternatively, the water may be added to the mixture in a sufficient amount after the mixture is placed in the pest's burrow. The requisite water quantity may be added with a material such as ground wood, saw dust, or ground cellulosic matter comprising about 30% water by weight and adding the material to the carbonate and acid mixture so that the carbonate, acid and water are present in about equal molar ratios. Preferably, excess amounts of water are not present or used, as the excess water will cause the formation of carbonic acid which in turn will react with portions of the carbonate compounds present to produce bicarbonate compounds as shown in the following chemical equations 2 and 3:

CO₂+H₂O→H₂CO₃ (2)

H₂CO₃+CaCO₃→Ca(HCO₃)₂ (3)

The production of bicarbonate compounds is undesirable as it affects the amount and availability of the carbon dioxide gas, which in turn will greatly reduce the degree of toxicity of the ambient air-CO₂ content in the pest's burrow.

The method of the present invention involves using a mixture comprising at least one carbonate compound with at least one acid compound in about equal parts to produce carbon dioxide gas. The mixture may be pre-prepared or made by mixing at least one anhydrous, powered or granular, carbonate compound with about a stoichiometric equal amount of at least one acid compound. The method of the present invention further contemplates adding a specified amount of water to generate the desired quantity of CO₂ gas but not form carbonic acid.

The carbonate compound is preferably anhydrous, powered or granular. Examples of suitable carbonate compounds include calcium carbonate, magnesium carbonate, sodium carbonate, sodium bicarbonate, and the like. Suitable sources of such carbonate compounds include limestone, dolomite, soda ash, baking soda, and the like. Suitable acid compounds include Ca(HSO₄)₂, Mg(HSO₄)₂, Mg(HSO₄)₂ Ca(HPO₄)₂, CaHPO₄, MgHPO₄, and the like.

Suitable sources of such acid compounds include acid sulfate and acid phosphate salt as present in “superphosphate” fertilizers as well as in products which are made by treating compounds such gypsum, tricalcium phosphate, and similar chemical substances with concentrated sulfuric acid, concentrated phosphoric acid, or both. For example, poultry excrement or poultry litter treated with concentrated acid may be used as the source of the acid compound, such as that disclosed in U.S. Ser. No. 09/400,201, filed Sep. 21, 1999, which is herein incorporated by reference. Preferred sources of acid compounds are dry, solid, anhydrous and granular, and produce free acid upon hydrolysis, but remain stable in the anhydrous state. The amount of carbonate and the amount of acid in the mixture preferably provide about a 1:1 stoichiometric ratio.

The sufficient amount of water is that which enables the reaction of the carbonate and acid to yield CO₂. The water may be added with a material such as ground wood, saw dust, or ground cellulosic matter comprising about 30% water by weight and adding the material to carbonate and acid mixture so that the carbonate, acid and water are present in about equal molar ratios. Preferably, excess amounts of water are not added for the reasons previously described. One of ordinary skill in the art may with routine methods calculate the amount of the carbonate compound and the amount of the acid compound necessary for producing the amount of toxic carbon dioxide gas required for a given burrow.

The composition of the present invention is placed in the pest's burrow. Preferably, the composition is poured into one or more burrow openings and then the sufficient amount of water is added. Preferably, about 2 to about 4 ounces of the composition per hole are used.

The presence of the wetted material such as sawdust in the burrow not only provides a source of water for the CO₂ gas generation-hydrolysis-reaction, but also provides a source of water for the burrowing pest along with a natural bedding material source. If acidulated poultry litter is used as a source of the acid compound, the litter provides an attractive animal aroma along with a food source of hydrolyzed carbohydrates (sugar) and solubilized animal protein. Thus, the composition of the present invention will attract the pest rather than scare the pest away as do the prior known methods and devices which involve violent moving gases, combustion engines, vibrations, and noise.

In addition to pest extermination, the present invention provides a method of providing nutrition to soil and plants by adding to the burrow or tunnel the composition of the present invention. Adding the composition to the burrow or tunnel of a subterranean burrowing pest provides nutrition at the root level of plants. The presence of oxyacid compounds possessing oxidative and catalytic capacities promote chemical decomposition of organic matter and cellulosic material such as that found in poultry litter. Other dry animal excrements may also be used.

Compositions that are suitable for providing nutrition to soil and plants comprise nitrogen, phosphorus, potassium, or a combination thereof, which can be solubilized and converted into nutrients available to plants by treating with a concentrated acid such as sulfuric acid or phosphoric acid and then reacting with a carbonate compound. Suitable nitrogen, phosphorus, or potassium compounds and compositions include those comprising amino acid, adenine, adenylic acid, adenosine, sulfate salt, phosphate salt, uric acid, ammonia, ammonium, ammonium sulfate, bisulfite, potassium phosphate, ammonium phosphate, or a combination thereof. The following chemical equations (4) and (5), show that soluble organic compounds, as well as carbon dioxide, are provided by reacting an acidified compound with a carbonate compound:

NH₄HSO₄+CaCO₃→CaSO₄.H₂O+NH₃+CO₂ (4)

NH₄(H₂PO₄)+CaCO₃→CaHPO₄+NH₃+CO₂+H₂O (5)

The following Examples are intended to illustrate but not to limit the invention.

### EXAMPLE 1

### Poultry Litter Composition

About 550 parts of moisture-free pulverized agricultural grade gypsum (about 80% or more CaSO₄.2H₂O) was thoroughly combined with about 150 parts of dried poultry litter. Both the gypsum and the poultry litter were about 90% finer than 10 mesh U.S. Standard Sieve size. To the mixture was added about 300 parts of concentrated sulfuric acid having a strength of about 93% to about 95%. The mixture was then allowed to stand until it reached ambient temperature (about 10 to about 20 minutes at room temperature). The mixture was dried at about 100° C. to about 105° C. The dried mixture was combined with about 300 parts of anhydrous calcium carbonate. The calcium carbonate was in a powdered form which was about 90% or more finer than 60 mesh U.S. Standard Sieve size. The final product may be used immediately or stored in a closed container to prevent exposure to moisture.

### EXAMPLE 2

### Cow Manure Composition

About 60 parts of moisture-free pulverized agricultural grade gypsum (about 80% or more CaSO₄.2H₂O) having a particle size of about 90% finer than 10 mesh U.S. Standard Sieve size was mixed with about 10 parts of sawdust having about 10 to about 20% moisture content. Then about 30 parts of fresh cow manure was added. After thoroughly mixing about 30 parts of concentrated sulfuric acid having a strength of about 93% to about 95% was added. The mixture was then heated to about 95° C. to about 105° C. to remove any free water and moisture. To this dried semi-granular product about 30 parts of 90% or more of finely ground anhydrous CaCO₃ was added and thoroughly mixed. The final product may be used immediately or stored in a moisture free container for subsequent use.

To the extent necessary to understand or complete the disclosure of the present invention, all publications, patents, and patent applications mentioned herein are expressly incorporated by reference therein to the same extent as though each were individually so incorporated.

Having thus described exemplary embodiments of the present invention, it should be noted that the within disclosures are exemplary only and that various other alternatives, adaptations, and modifications may be made within the scope of the present invention. Accordingly, the present invention is not limited to the specific embodiments as described herein, but is only limited by the following claims.

What is claimed is:

1. A composition comprising at least one carbonate compound and animal litter having at least one acid compound, which composition yields carbon dioxide gas when in the presence of a sufficient amount of water.

2. The composition of claim 1, wherein the carbonate compound and the acid compound are in amounts which provide about a 1:1 stoichiometric ratio.

3. The composition of claim 1, wherein the carbonate compound is calcium carbonate, magnesium carbonate, sodium carbonate, or sodium bicarbonate.

4. The composition of claim 1, wherein the acid compound is Ca(HSO₄)₂, Mg(HSO₄)₂, Mg(HSO₄)₂ Ca(HPO₄)₂, CaHPO₄, or MgHPO₄.

5. The composition of claim 1, wherein the carbonate compound is anhydrous and powdered or granular.

6. The composition of claim 1, wherein the acid compound is provided by a source which is dry, solid, anhydrous, and granular.

7. A method of making carbon dioxide gas comprising adding to a composition comprising at least one carbonate compound and animal litter having at least one acid compound a sufficient amount of water to generate carbon dioxide gas.

8. The method of claim 7, wherein the carbonate compound and the acid compound are in amounts which provide about a 1:1 stoichiometric ratio.

9. The method of claim 7, wherein the carbonate compound is calcium carbonate, magnesium carbonate, sodium carbonate, or sodium bicarbonate.

10. The method of claim 7, wherein the acid compound is Ca(HSO₄)₂, Mg(HSO₄)₂, Mg(HSO₄)₂ Ca(HPO₄)₂, CaHPO₄, or MgHPO₄.

11. The method of claim 7, wherein the carbonate compound is anhydrous and powdered or granular.

12. The method of claim 7, wherein the acid compound is provided by a source which is dry, solid, anhydrous, and granular.

13. The method of claim 7, wherein the water is added in the form of a material comprising about 30% water by weight.

14. The method of claim 13, wherein the material is ground wood, sawdust, or ground cellulosic material.

15. A method of exterminating a subterranean burrowing pest comprising placing in a burrow or tunnel of the subterranean burrowing pest a composition comprising at least one carbonate compound and at least one acid compound sufficient to form CO₂ gas upon the addition of water.

16. The method of claim 15, wherein the carbonate compound and the acid compound are in amounts which provide about a 1:1 stoichiometric ratio.

17. The method of claim 15, wherein the carbonate compound is calcium carbonate, magnesium carbonate, sodium carbonate, or sodium bicarbonate.

18. The method of claim 15, wherein the acid compound is Ca(HSO₄)₂, Mg(HSO₄)₂, Mg(HSO₄)₂ Ca(HPO₄)₂, CaHPO₄, or MgHPO₄.

19. The method of claim 15, and further comprising adding a sufficient amount of water to enable a chemical reaction between the carbonate compound and the acid compound to give a toxic amount of carbon dioxide.

20. The method of claim 19, wherein the sufficient amount of water is added in the form of a material including about 30% water by weight.

21. The method of claim 15, wherein the acid compound is from a superphosphate fertilizer or a compound or composition treated with concentrated acid.

22. The method of claim 15, wherein the carbonate compound is from limestone, dolomite, soda ash, or baking soda.

23. A method of providing nutrition to soil and plants comprising adding to a burrow or tunnel of a subterranean burrowing pest the composition of claim 1.
